(19) United States
(12) Patent Application Publication
(10) Pub. No.: US 2026/0245765 A1
(43) Pub. Date: Aug. 20, 2026

(54) Method for controlling an atom interferometer, atom interferometer and computer program

(71) Applicant: DEUTSCHES ZENTRUM FÜR LUFT- UND RAUMFAHRT E.V., Bonn-Oberkassel (DE)

(72) Inventors: Sandra GERLACH, Hannover (DE); Christian DEPPNER, Hannover (DE); Waldemar HERR, Hannover (DE); Christian SCHUBERT, Hannover (DE); Holger AHLERS, Hannover (DE)

(21) Appl. No.: 19/394,044

(22) Filed: Nov. 19, 2025

(30) Foreign Application Priority Data
Nov. 19, 2024 (DE) 10 2024 133 876.8

(51) Int. Cl. G21K 1/30

(52) U.S. Cl. CPC G21K 1/30

(57) ABSTRACT

The invention relates to a method, wherein at least one ensemble of atoms is prepared in an output-coupled state (Z1), and the state of the at least one ensemble of atoms is changed into subsequent states by means of the at least one ensemble of atoms in an atom interferometer input state, which is the same as the output-coupled state (Z1) or differs therefrom following the application of further manipulation steps, and by way of coherent control interventions acting on said at least one ensemble of atoms, the subsequent states differing from the atom interferometer input state, and a matter wave interferometry sequence, which may have multiple loops in particular, is performed using the at least one ensemble of atoms. The invention also relates to an atom interferometer that is configured to carry out such a method and to a computer program for carrying out such a method.

### FIELD OF THE INVENTION

The invention relates to a method, wherein at least one ensemble of atoms is prepared in an output-coupled state (Z1), and the state of the at least one ensemble of atoms is changed into subsequent states by means of the at least one ensemble of atoms in an atom interferometer input state, which is the same as the output-coupled state (Z1) or differs therefrom following the application of further manipulation steps, and by way of coherent control interventions acting on said at least one ensemble of atoms, the subsequent states differing from the atom interferometer input state, and a matter wave interferometry sequence, which may have multiple loops in particular, is performed using the at least one ensemble of atoms. The invention also relates to an atom interferometer that is configured to carry out such a method and to a computer program for carrying out such a method.

### BACKGROUND

Sensors based on atom interferometry may offer highly sensitive, long-term stable and absolute-precision measurements, e.g. of accelerations and rotations. Both atom-interferometric rotation measurements and acceleration measurements have been demonstrated, especially in gravimeters. There are commercial versions of atom-interferometric gravimeters and portable versions used in marine and airborne gravimetric campaigns. One challenge here is the implementation of compact structures.

### Publications

R1: Atom-Chip Fountain Gravimeter
S. Abend, M. Gebbe, M. Gersemann, H. Ahlers, H. Müntinga, E. Giese, N. Gaaloul, C. Schubert, C. Lämmerzahl, W. Ertmer, W. P. Schleich, and E. M. Rasel Phys. Rev. Lett. 117, 203003-Published Nov. 11, 2016
R2: A transportable quantum gravimeter employing delta-kick collimated bose-Einstein condensates
Nina Heine, Jonas Matthias, Maral Sahelgozin, Waldemar Herr, Sven Abend, Ludger Timmen, Jürgen Müller & Ernst Maria Rasel
Published: Aug. 25, 2020
R3: Multi-loop atomic Sagnac interferometry
Christian Schubert, Sven Abend, Matthias Gersemann, Martina Gebbe, Dennis Schlippert, Peter Berg & Ernst M. Rasel
Published: Aug. 9, 2021
R4: Composite-Light-Pulse Technique for High-Precision Atom Interferometry
P. Berg, S. Abend, G. Tackmann, C. Schubert, E. Giese, W. P. Schleich, F. A. Narducci, W. Ertmer, and E. M. Rasel
Published Feb. 9, 2015

### SUMMARY

The problem addressed by the invention is that of optimizing such an atomic interferometer in view of an advantageous practical structural realization.

In a method as set forth at the outset for controlling an atom interferometer, this problem is solved on the basis of a Cartesian coordinate system with x, y and z axes, with the z-axis for example possibly being aligned in the effective direction of gravity should the atom interferometer be operated in a gravitational field, by virtue of the at least one ensemble of atoms being moved from an initial position in a first direction with a spatial component in the xy-plane, with the following steps being carried out:
a) once a path to a first reversal point has been traveled in the first direction, moving the at least one ensemble of atoms in a second direction, which differs from the first direction but also has a spatial component in the xy-plane, by irradiation with at least one first coherent relaunch control intervention,
b) once a path in the second direction has been traveled, moving the at least one ensemble of atoms in the direction of the surroundings of the first reversal point by irradiation with at least one second coherent relaunch control intervention such that the at least one ensemble of atoms has a looped trajectory in the xy-plane,
c) repeating back-and-forth movements of the at least one ensemble of atoms with a looped trajectory in the xy-plane by means of further coherent relaunch control interventions until a predefined number of back-and-forth movements of the at least one ensemble of atoms is reached,
d) completing the interferometry sequence by irradiating the at least one ensemble of atoms with at least one final coherent control intervention and detecting the interferometer outputs.

This allows an advantageous multi-loop geometry in the xy-plane to be realized independently of a gravitational field. The multi-loop geometry allows for high measurement accuracy and resolution of the interferometric process while requiring little installation space for the atom interferometer. This is rendered possible by virtue of the movement of at least one ensemble of atoms not being limited to one and the same spatial direction during the interferometry sequence, which would correspondingly require a relatively large installation space for obtaining a high resolution, but instead comprising multiple back-and-forth movements in the style of a loop, with the number of back-and forth-movements, i.e. the number of loops or looped trajectories, being able to be defined in the respective application. This enables variable scaling of an atom interferometer. In particular, such an atom interferometer may be realized as a compact, portable atom-interferometric six-axis or multi-axis inertial sensor also offering the possibility of rotation measurements.

The scaling factor of typical atom interferometers with atoms in free fall depends on the effective wave number of the beam splitter light field required for the coherent manipulation of the atoms for forming the interferometer and on the free-fall time or free development time between successive beam splitter pulses during the interferometer process. This time is limited by the size of the vacuum chamber in which the atoms are captured and manipulated. There are the possibilities of captured or guided interferometers as solution approaches, but this contains additional demands on the structure.

By contrast, the present invention makes use of an atom “relaunch” after a certain period of time such that the atoms pass through the vacuum chamber multiple times. Building on this approach, a concept for a rotation sensor is proposed, in which repeated relaunching of the atoms results in an enclosed area being repeatedly orbited, whereby the effectively enclosed area is enlarged, and the scaling factor is increased in a manner analogous to a fiber gyroscope. Earth-based, this multi-loop concept can be measured in the direction of at least one of the three spatial axes as a matter of principle.

In contrast with the prior art, the method according to the invention advantageously enables a measurement of rotational movements about at least one, several or all three spatial axes both in the gravitational field with atoms in free fall and in a weightless environment. In particular, the method according to the invention does not require any gravitational acceleration for the purpose of spanning interferometer areas or loops.

Accordingly, the method according to the invention and the atom interferometer carrying out the method may be used either in a gravitational field, e.g. in the Earth's gravitational field, or in a weightless environment. The z-axis should be aligned with the effective direction of gravity when the atom interferometer is operated in a gravitational field; the alignment is irrelevant in a state of weightlessness. In the method according to the invention, spatial movements of the ensemble of atoms in the xy-plane, which is also referred to below as horizontal plane or horizontal direction, are advantageously used to span interferometer areas or loops. Influencing of the spatial movements of the ensemble is rendered possible by the coherent relaunch control interventions, by means of which the direction of the ensemble of atoms in the horizontal direction and/or else in the vertical direction (z-direction) is inverted.

The aforementioned ensemble of atoms, which is sometimes also referred to as atom ensemble or atom cloud in the literature, may also be described as matter wave(s) or as atoms that are in a coherent superposition state. In this application, the expression “ensemble of atoms” should be used as the general generic term therefor.

At the outset, the ensemble of atoms is in an output-coupled state (Z1), the output-coupled state (Z1) describing the state following cooling methods and/or other preparation steps or generally the state preceding the steps that now follow and being present in particular before performing further control interventions and the coherent control interventions of the matter wave interferometry sequence. Then, the ensemble of atoms is converted into the atom interferometer input state by the aforementioned control interventions, e.g. by virtue of the ensemble of atoms being acted upon by at least one momentum eigenstate transfer and/or further preparation steps optionally being performed. Then the matter wave interferometry sequence with multiple coherent control interventions is performed, within the scope of which the ensemble of atoms may have one or more different subsequent states, e.g. from the first to the last coherent control intervention.

Such coherent control interventions may be e.g. the application of light pulses, e.g. from a laser or another light source, magnetic field gradients and/or microwave pulses on the at least one ensemble of atoms, or -in general terms-any desired methods for coherently manipulating the ensemble of atoms, i.e. a form of quantum control that uses the wave properties of matter in order control the development of a quantum system over time in a desired manner. As a rule, multiple coherent control interventions are performed over the course of the matter wave interferometry sequence. Here, the term “pulse” is understood as a generic term for any types of periodic and non-periodic events, with the term “pulse” also including an impulse, e.g. in the form of a periodically repeating sequence of impulses, periodically repeating impulse-like or shock-like events and/or, in the case of a light pulse, the light power rising and falling once or multiple times.

According to an advantageous configuration of the invention, provision is made for the coherent superposition states of the atoms, e.g. as a result of the at least one ensemble of atoms on looped trajectories, to enclose an area that has a spatial component in the directions of the x-axis and the y-axis. This encloses a horizontal area. This allows an atom interferometer carrying out the method according to the invention to be used either in a gravitational field or in a weightless environment without any modifications.

According to an advantageous configuration of the invention, provision is made for the coherent superposition states of the atoms on looped trajectories to form a multi-loop geometry. In particular, the at least one ensemble of atoms may propagate along multiple loops of the looped trajectories, e.g. two, three, four or more loops.

According to an advantageous embodiment of the invention, provision is made during the back-and-forth movements for the coherent superposition states to be irradiated with at least one coherent deflection control intervention, the effective direction of which makes an angle other than zero with the effective direction of the coherent relaunch control interventions, e.g. is orthogonal to the latter. Such deflection control interventions enable comprehensive control of the traveled trajectories of the at least one ensemble of atoms in the horizontal direction. For example, the relaunch control interventions may act in the positive and negative x-directions, and the coherent deflection control interventions may act in the positive and negative y-directions. In this case, the effective direction of the respective coherent control intervention is considered to be the direction of the vector of momentum eigenstate transfer to the at least one ensemble of atoms.

According to an advantageous configuration of the invention, provision is made for the effective direction of the coherent relaunch control interventions and/or the effective direction of the coherent deflection control interventions to have at least one spatial component in the directions of the x-axis and/or the y-axis. One or both types of specified coherent control interventions may thus have at least one spatial component of its effective direction in the horizontal direction.

According to an advantageous configuration of the invention, provision is made for the coherent superposition states of the atoms to not be fully confined to the first and second spatial directions during their movement along them. Hence the invention may also be used in non-confined interferometers, in which the at least one ensemble of atoms can move substantially freely, i.e. is not confined in a targeted manner.

According to an advantageous configuration of the invention, provision is made for the states of the atoms of the at least one ensemble of atoms to be changed by at least one coherent beam splitter control intervention that acts on the at least one ensemble of atoms, in such a way that their state comprises at least two partial position probabilities of the atoms with different momentum eigenstates, the components of the different momentum eigenstates having directional components each with a spatial component in the xy-plane and pointing away from one another, with control interventions for changing the state into the atom interferometer input state then being able to be applied, with the matter wave interferometry sequence then being applied, with the aforementioned steps a) to d) being applied to the respective partial position probabilities of the atoms. This allows the realization of at least two interferometers by means of the one ensemble of atoms in which the aforementioned coherent beam splitter control intervention is performed, the latter causing the generation of the at least two partial position probabilities of the atoms with different momentum eigenstates, i.e. the generation of two independent partial ensembles of atoms, as it were. The two interferometers generated as a result may thus each be evaluated separately with regard to their interferometer outputs. In this way, the invention may advantageously be extended to all types of acceleration measurements and rotation measurements without requiring a substantial increase in the installation space.

In this context, interferometer outputs are understood to mean the states of the ensemble of atoms or the partial position probabilities thereof at the end of the matter wave interferometry sequence, at which the interference of waves can be measured. For example, a camera may be used to this end, the field of view of said camera being able to be directed through a viewing glass into a vacuum chamber of the atom interferometer and the camera being able to detect and evaluate the ensembles of atoms in the process.

In an advantageous configuration of the invention, the at least two partial position probabilities of the atoms with different momentum eigenstates may execute back and forward movements and enclose looped trajectories in the process, with the movement directions of the partial position probabilities possibly being opposite to one another along their trajectories, e.g. by virtue of the partial position probabilities with their opposing movements each enclosing an area that has a spatial component in the directions of the x-axis and the y-axis (i.e. a horizontal area).

According to an advantageous configuration of the invention, provision is made for a symmetric or quasi-symmetric beam division of the at least one ensemble of atoms into the at least two partial position probabilities of the atoms in the directions of the x-axis and the y-axis to be performed. In the case of a symmetric beam division, the effective direction of the coherent beam splitter control intervention may be substantially orthogonal to the initial velocity of the at least one ensemble of atoms. In the case of quasi-symmetric beam splitting, the effective direction might not be orthogonal, and so this gives rise to a symmetrized course of the trajectories.

According to an advantageous configuration of the invention, provision is made for symmetric or symmetrized or quasi-symmetric beam splitting processes to be used for the control interventions or as part of the control interventions for the matter wave interferometry sequence and/or the relaunch control interventions.

According to an advantageous configuration of the invention, provision is made for two separated ensembles of atoms to be captured in separate, spaced apart atom traps, with two separate or partially or completely overlapping interferometers being formed with the aid of the separate ensembles of atoms, with the separate ensembles of atoms being moved in directions pointing away from one another or partly pointing away from one another, the directions each having a spatial component in the xy-plane, with aforementioned steps a) to d) being applied to the respective separate ensembles of atoms. This creates an advantageous alternative to the division of the at least one ensemble into the aforementioned at least two partial position probabilities by virtue of the method using two spaced apart atom traps and separated ensembles of atoms trapped therein. In this case, the aforementioned coherent beam splitter control intervention for splitting into the at least two partial position probabilities can be omitted.

According to an advantageous configuration of the invention, provision is made for the coherent control interventions of the matter wave interferometry sequence to act on the at least one ensemble of atoms in the initial state or in different initial states before or after the coherent relaunch control intervention. In the case of light pulses as coherent control interventions, these may be radiated onto the ensemble of atoms or the partial position probabilities e.g. before or after the relaunch control intervention. This enables large degrees of freedom in the practical realization of an atom interferometer.

According to an advantageous configuration of the invention, provision is made for acceleration values and/or rotation values in one, several or all axes x, y, z to be calculated by evaluating the interferometer outputs. It is possible in this way to determine acceleration values and/or rotation values in one, several or all directions of the 3-D space.

The problem mentioned at the outset is also solved by an atom interferometer having at least one atom trap and at least one controllable coherent signal source for emitting coherent control interventions of the matter wave interferometry sequence, coherent beam splitter control interventions, coherent deflection control interventions and/or coherent relaunch control interventions, and having at least one control device for controlling at least the at least one coherent signal source, wherein the control device is configured to carry out a method of the type explained above. This also makes it possible to achieve the advantages set out above. The different types of the aforementioned control interventions may be emitted by a single coherent signal source or by different coherent signal sources. In this case, the control device may advantageously take the form of a computer-controlled control device that is configured to execute a computer program. In this way, the atom interferometer may be designed with regard to the functionality by way of appropriate programming of the computer program, in particular by virtue of being formed to carry out a method of the type described above by means of the computer program.

The problem mentioned at the outset is also solved by a computer program product comprising commands that cause the atom interferometer of the above-described type to carry out the method steps of the above-described type when the computer program is executed on a computer of the control device of the atom interferometer. This also makes it possible to achieve the advantages set out above. The computer program may be stored on a storage medium. The computer program may take the form of software, firmware or hardware programming of a PLD (programmable logic device) or a combination thereof.

The invention is suitable e.g. for applications in the field of navigation, for rotation and acceleration measurements, e.g. as part of an inertial quantum measurement unit serving to assist or replace conventional inertial measurement units, especially in regions without a reliable global navigation system (GNSS).

In the context of the present invention, the indefinite article “a(n)” should not be understood as meaning a number. For example, if mention is made of a component, this is to be interpreted in the sense of “at least one component”. Insofar as angle specifications are given in degrees, they refer to a circular measure of 360 degrees (360°).

Insofar as a computer is mentioned, the latter may be configured to execute a computer program, e.g. in the sense of software. The computer may take the form of a commercially available computer, e.g. a PC, laptop, notebook, tablet or smartphone, or the form of a microprocessor, microcontroller or PLD (programmable logic device) or a combination of such elements.

The invention contains the possibility of the following properties:
1. By applying the multi-loop geometry for rotation measurements, the subject matter of this invention, when used on Earth, can measure the third spatial axis or rotation component.
2. Compared to existing concepts with free-falling atoms, which are already capable of measuring this third spatial axis in a complementary manner, the subject matter of this invention offers the possibility of implementing a multi-loop geometry, i.e. an additional possibility of adapting and increasing the scaling factor, without requiring a larger vacuum system.
3. The invention can also be used in weightlessness and measure all three axes of rotation in this case.
4. In contrast to existing concepts with free-falling atoms which could already measure all three spatial axes without multiple loops, the subject matter of this invention offers the possibility of implementing a multi-loop geometry, i.e. an additional possibility of adapting and increasing the scaling factor, without requiring a larger vacuum system.

### DESCRIPTION OF THE DRAWINGS

The invention is explained in more detail below with reference to exemplary embodiments and using drawings, in which:

FIG. 1 shows a schematic illustration of an atom interferometer in the xz-plane,

FIG. 2 shows the atom interferometer as per FIG. 1 in the xy-plane,

FIG. 3 shows a matter wave interferometry sequence in the xz-plane,

FIG. 4 shows the matter wave interferometry sequence as per FIG. 3 in the xy-plane,

FIG. 5 shows a matter wave interferometry sequence with symmetrized beam splitting in a single pass,

FIG. 6 shows a matter wave interferometry sequence with symmetrized beam splitting in a multi-loop geometry.

### DETAILED DESCRIPTION

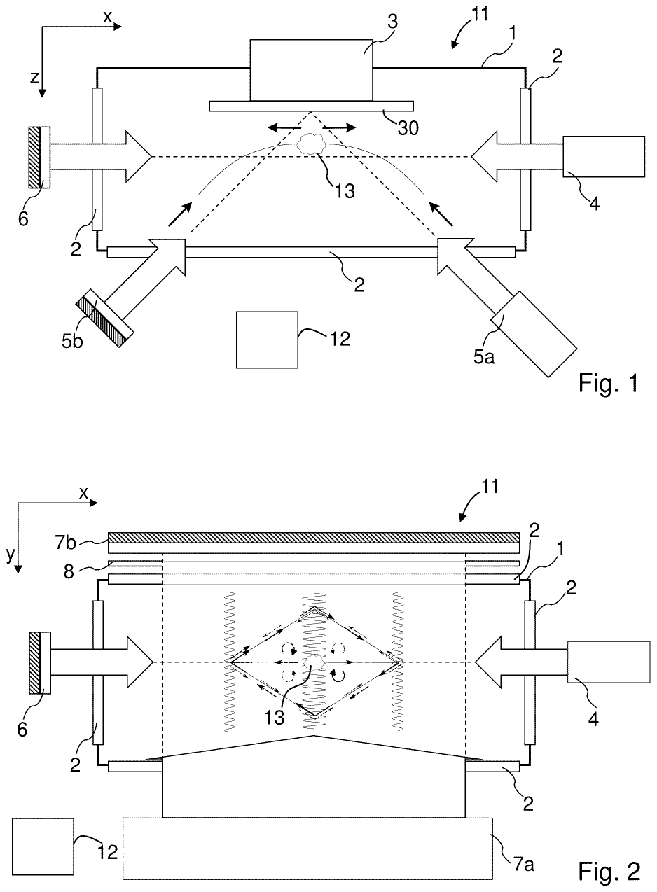

FIGS. 1 and 2 show an atom interferometer 11 in a simplified schematic illustration, especially in view of the optics implementation in a sensor head. The atom interferometer 11 has a vacuum chamber 1, which has optically transparent viewing windows 2 on multiple sides. For example, the vacuum chamber 1 may have a cubic shape. Moreover, the atom interferometer 11 also has an atom trap 3, e.g. an atom chip holder with an atom chip 30, e.g. with a highly reflective surface. Alternatively, the atom interferometer 11 may also have a different type of atom trap, e.g. an optical dipole trap or a magneto-optical trap (MOT). In the case of an optical dipole trap, the viewing windows 2 may also be transmissive to optical dipole trap laser beams and highly reflective to relaunch laser beams or other coherent control interventions.

Further, the atom interferometer 11 has a beam shaping optics unit 4, e.g. for the initial momentum eigenstate transfer of the ensemble of atoms 13 captured in the atom trap 3 into the initial state and optionally for further coherent control interventions. Moreover, the atom interferometer 11 has a mirror 6 arranged diametrically opposite the beam shaping optics unit 4. For example, the beam shaping optics unit 4 may comprise one or more collimators and/or flat-top or top-hat beam shapers. Furthermore, the atom interferometer 11 has a beam shaping optics unit 5a arranged obliquely with respect to the atom trap 3 and a mirror 5b interacting therewith, by means of which the beams of the beam shaping optics unit 5a are reflected. The beam shaping optics unit 5a serves for emitting the relaunch laser beams or, in general terms, for the coherent relaunch control interventions.

The beam shaping optics unit 5a and/or the mirror 5b may be fixedly set or adjustable. They may also be adjustable in motorized fashion in order for example to be able to set the angle of coherent relaunch control interventions. Furthermore, the atom interferometer 11 has conventional known elements of such atom interferometers, which are not shown for the sake of simplicity, e.g. coils or a 2-D magneto-optical trap.

The atom interferometer 11 moreover has a beam shaping optics unit 7a for feeding in the coherent control interventions of the matter wave interferometry sequence. A mirror 7b is arranged opposite the beam shaping optics unit 7 in the beam direction. A retardation plate 8, which may or may not be required depending on the beam splitter concept, might be arranged in front of the mirror 7b. The mirror 7b and/or the mirror 6 may be arranged either within or outside of the vacuum chamber 1.

The atom interferometer 11 may also have a beam shaping optics unit 8 for feeding detection light (for an absorption recording) into the vacuum chamber 1 and at least one camera for the detection of the interferometer outputs, e.g. a CCD or CMOS camera with an upstream detection optics unit, e.g. a dual-lens system for magnification and/or size reduction and optionally for stray light suppression, but this is not plotted in FIGS. 1 and 2. The atom interferometer 11 has a control device 12, by means of which the individual controllable components of the atom interferometer 11 can be controlled. The control device 12 is configured to carry out a method of the described type.

The invention includes the possibility of combining the following elements and functions:
1. A system for the spatially resolved detection of atoms, e.g. by way of absorption recordings using a camera, e.g. an atom interferometer having a sensor head, comprising a vacuum system with optical accesses, and peripheral elements such as beam shaping optics units, coils, etc. with the functionalities of
   1.1 capturing and cooling atoms, e.g. using a 3-D magneto-optical trap, an optical dipole trap or a magnetic trap or an atom chip in single or multiple embodiments depending on the implementation,
   1.2 being able to perform beam splitter operations for implementing the interferometer along at least one axis,
   1.3 being able to relaunch atoms with a defined speed and direction at defined times and defined locations,
   1.4 being able to detect the interferometer outputs,
2. a laser system for providing the laser light or any other system for providing coherent control interventions, e.g. for capturing and cooling, for the beam splitter operations, for relaunching depending on the implementation approach,
3. an electronics system including a control computer, e.g. in the form of the control device 12, e.g. for the active elements in the sensor head and laser system, carrying out the measurement sequences, recording data and optionally processing the data,
4. each designed such that they allow a multi-loop operation.

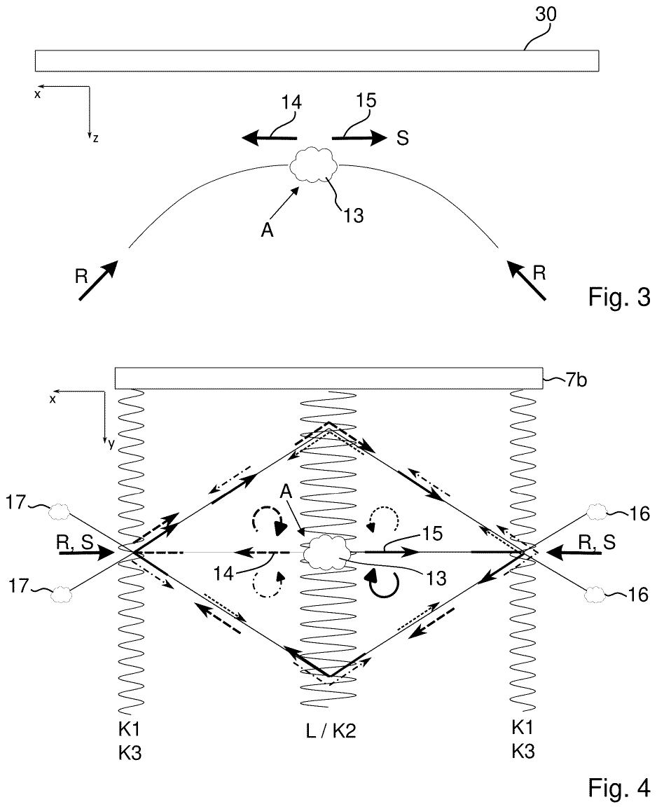

A first embodiment of an interferometry method according to the invention with a matter wave interferometry sequence and a multi-loop geometry is explained on the basis of FIGS. 3 and 4. The start of two individual interferometers is initially depicted on the basis of FIG. 3. Initially, a first coherent beam splitter control intervention S, e.g. a first π/2 pulse in the case of light pulses, is applied to an ensemble of atoms 13 at an initial position A, which may be a central location in the vacuum chamber 1. As a result, the ensemble of atoms 13 is split into two partial position probabilities 14, 15 of the atoms, corresponding to beam splitting. These partial position probabilities 14, 15 move to the left and right respectively, i.e. in the positive and negative x-directions, at speeds of −V_{SEP}, V_{SEP}. Should there be a gravitational influence, the partial position probabilities 14, 15 additionally move in the direction of gravity g, i.e. in the z-direction. After a certain amount of time, a coherent relaunch control intervention R is applied to the respective partial position probabilities 14, 15 in order to generate a relaunch process for the partial position probabilities 14, 15.

In this context, FIG. 4 shows the trajectories of the partial position probabilities 14, 15 in the xy-plane generated by the various coherent control interventions. In this case, the arrows with solid and short-dashed lines show the trajectories and revolution directions of the partial position probability 15 starting to the right, and the arrows with dash-dotted and long-dashed lines show the trajectories and revolution directions of the partial position probability 14 starting to the left. In the process, it is possible to generate multiple revolutions of the partial position probabilities 14, 15 or—in general—of the at least one ensemble of atoms 13, with the depicted trajectories that enclose an area in the xy-plane being traversed in each case by virtue of the coherent relaunch control interventions R and the coherent deflection control interventions L between the relaunch control interventions R being carried out multiple times. The deflection control intervention L may correspond to the control intervention K2.

The coherent control interventions of the matter wave interferometry sequence K1, K2 or L and K3 are carried out successively in time in this case. A third coherent control intervention K3, e.g. in the form of a second π/2 pulse, is applied to the respective partial position probabilities 14, 15 at the end of the matter wave interferometry sequence. Thereafter, a detection and evaluation of the interferometer outputs 16, 17 of the two interferometers formed by the partial position probabilities 14, 15 may be carried out.

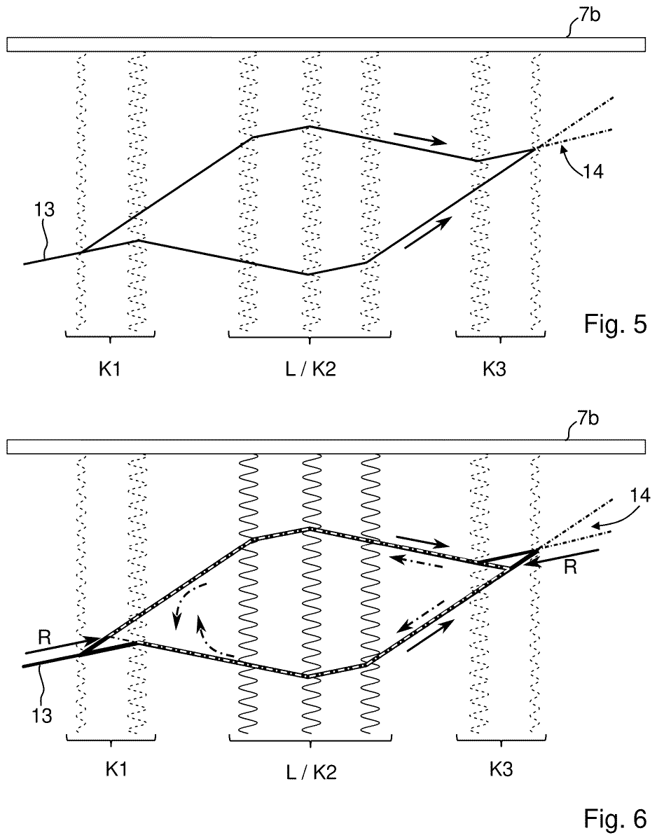

FIGS. 5 and 6 show an implementation of the described multi-loop geometry with symmetrized or quasi-symmetric beam splitting instead of the symmetric beam splitting according to FIGS. 3 and 4. Such a configuration enables the operation of the atom interferometer 11 in the case of a non-vanishing velocity of the atoms vis-à-vis the beam splitter light fields, especially in the y-direction. FIG. 5 shows a single pass of an interferometry sequence, as known from the prior art. FIG. 6 shows an embodiment according to the invention in multi-loop geometry, i.e. with multiple movements of the at least one ensemble of atoms 13 back and forth with a loop-shaped trajectory in the xy-plane, as depicted by the arrows in a manner analogous to FIG. 4.

A possible implementation according to FIGS. 3 and 4 may be as follows:
1. An ultra-cold atomic ensemble, e.g. a Bose-Einstein condensate, is generated under an atom chip 3. The latter is output-coupled from the trap and falls downward (z-direction) FIG. 3.
2. A beam splitting process S generates a superposition of two momentum eigenstates (ensembles 14, 15), which move apart in the x-direction perpendicular to the z-axis with opposite momentum FIG. 3.
3. After a time of free fall, the movement of the two ensembles 14, 15 is inverted by the relaunch process (relaunch control interventions R), and so they move toward one another again. An exact inversion is not required. This may be adapted in accordance with a favorable implementation FIG. 3.
4. The beam splitter light fields or other coherent control interventions K1, K2 or L, K3 for spanning the interferometer are applied perpendicular to the z-direction and x-direction (in the y-direction). The first coherent control intervention K1 is a so-called π/2 pulse which generates a coherent superposition between two momentum eigenstates symmetrically in the y-direction. After a time T, what is known as a coherent deflection control intervention L, for example a π pulse, is applied at or in the vicinity of the apex of the launch parabola, and it inverts the momentum eigenstates of the two ensembles 14, 15 in the y-direction FIG. 4.
5. Following a further free fall time T, the ensembles 14, 15 are relaunched again by relaunch control interventions R at or near the point where they were relaunched the first time. In this case, they are located at the point at which the respective other ensemble 14, 15 was relaunched previously. In this case, the relaunch time is chosen such that the two trajectories of the interferometers just cross FIG. 4.
6. After a further free fall time T, a further coherent deflection control intervention L, for example a π pulse, is applied at or in the vicinity of the apex of the launch parabola, and it inverts the momentum eigenstates in the y-direction FIG. 4.
7. After a further free fall time T, at or near the point at which the ensembles 14, 15 were relaunched the first time, where the trajectories just cross again, there are now two possibilities FIG. 4:
   7.1 The interferometer is closed by the application of a coherent control intervention K3, for example a π/2 pulse, and the interferometer output 16, 17 can be read out. The overall interferometer time is 4T, and two loops were run through on the trajectories.
   7.2 There is a further relaunch process by the relaunch control interventions R in order to run through further loops, and the final coherent control intervention K3 for closing the interferometer is applied after an overall interferometer time of 4T plus a multiple of 2T.

Depending on the implementation, the first and/or last loop may also have a different 2T than the loops in between, for example in order to satisfy technical restrictions. All types of coherent control interventions, for example the π/2 and π pulses, may be replaced by composite beam splitter pulses (see FIG. 6), higher-order beam splitter pulses or other methods for increasing the effective wave vector in order to additionally increase the scaling factor. Two interferometers are operated in parallel in the aforementioned implementation. This enables the suppression of vibration noise (acceleration noise). In principle, the operation of a single interferometer is also possible, where the acceleration noise then has to be suppressed in some other way.

In microgravitation, relaunching is only implemented in the X-direction.

Options for the technical implementation of the relaunch process:
1. Beam-splitting processes, optionally of higher order, sequentially in the x- and z-directions with light fields which are radiated in the x- and z-directions; in this case, the relaunching in the x-direction is implemented at the intersection point of the trajectories;
2. Beam-splitting processes, optionally of higher order, at a specific angle, e.g. 45° with respect to the atom chip surface; in this case, the light field is reflected back at the atom chip and then into itself; the beam guidance and the reflector may optionally be designed such that an angle change is possible, e.g. by way of controllable mirror holders.

1. A method for controlling an atom interferometer wherein at least one ensemble of atoms is prepared in an output-coupled state describing a state following cooling methods and/or other steps which precede the following steps, comprising:
changing a state of the at least one ensemble of atoms into subsequent states by means of the at least one ensemble of atoms in an atom interferometer input state which is identical to the output-coupled state or differs therefrom following the application of further manipulation steps, by way of coherent control interventions acting on said at least one ensemble of atoms,
wherein the subsequent states differing from the atom interferometer input state and include coherent superpositions,
performing a matter wave interferometry sequence using the at least one ensemble of atoms, wherein on a basis of a Cartesian coordinate system with x, y and z axes, with the z-axis possibly being aligned in an effective direction of gravity should the atom interferometer be operated in a gravitational field, the operation of the atom interferometer also being possible in a state of weightlessness,
wherein the matter wave interferometry sequence moves the at least one ensemble of atoms from an initial position in a first direction with a spatial component in the xy-plane, wherein the following steps are carried out:
once a path to a first reversal point has been traveled in the first direction, moving the at least one ensemble of atoms in a second direction, which differs from the first direction but also has a spatial component in the xy-plane, wherein moving is performed by irradiation with at least one first coherent relaunch control intervention followed by application of coherent control interventions with a functionality of the at least one coherent relaunch control intervention being able to be combined with one of the coherent control interventions,
once a path in the second direction has been traveled, moving the at least one ensemble of atoms in a direction of surroundings of a first reversal point by irradiation with at least one second coherent relaunch control intervention and applying further coherent control interventions such that the at least one ensemble of atoms has a looped trajectory in the xy-plane,
repeating back-and-forth movements of the at least one ensemble of atoms with a looped trajectory in the xy-plane by means of further coherent relaunch control interventions until a predefined number of back-and-forth movements of the at least one ensemble of atoms is reached with coherent control interventions being applied again in order to form the looped trajectory, with successive looped trajectories optionally being able to be formed such that they overlap, almost overlap or deviate from an overlapping state, and
completing the interferometry sequence by irradiating the at least one ensemble of atoms with at least one final coherent control intervention and detecting the interferometer outputs.

2. The method as claimed in claim 1, wherein the coherent superposition states of the atoms on looped trajectories enclose an area that has a spatial component in the directions of the x-axis and the y-axis.

3. The method as claimed in claim 1, wherein the coherent superposition states of the atoms on looped trajectories form a multi-loop geometry.

4. The method as claimed in claim 1, wherein during the back-and-forth movements the coherent superposition states are irradiated with at least one coherent deflection control intervention which has an effective direction which makes an angle other than zero with the effective direction of the coherent relaunch control interventions.

5. The method of claim 4 wherein the angle other than zero is orthogonal.

6. The method as claimed in claim 1, wherein the effective direction of the coherent relaunch control interventions and/or the effective direction of the coherent deflection control interventions has at least one spatial component in the directions of the x-axis and/or the y-axis.

7. The method as claimed in claim 1, wherein the coherent superposition states of the atoms are not fully confined to the first and second spatial directions during movement respectively along the first and second spatial directions.

8. The method as claimed in claim 1, wherein states of the atoms of the at least one ensemble of atoms are changed into a transfer state by at least one coherent beam splitter control intervention that acts on the at least one ensemble of atoms such that their state comprises at least two partial position probabilities of the atoms with different momentum eigenstates, the different momentum eigenstates having at least one directional component each with a spatial component in the xy-plane and pointing away from one another, with subsequently further manipulation steps of the matter wave interferometry sequence being applied to the respective partial position probabilities of the atoms.

9. The method as claimed in claim 8, wherein a symmetric or symmetrized or quasi-symmetric beam division of the at least one ensemble of atoms into the at least two partial position probabilities of the atoms in the directions of the x-axis and the y-axis is performed.

10. The method as claimed in claim 1, wherein one or more symmetric or symmetrized or quasi-symmetric beam splitting processes are used for at least some of the control interventions.

11. The method as claimed in claim 1, wherein two separated ensembles of atoms are captured in separate, spaced apart atom traps, with two separate or partially or completely overlapping interferometers being formed with the aid of the two separated ensembles of atoms, with the two separated ensembles of atoms being moved in directions pointing away from one another or partly pointing away from one another, the directions each having a spatial component in the xy-plane, with subsequently steps being applied to the respective separate ensembles of atoms of the two separated ensembles of atoms.

12. An atom interferometer, comprising:
at least one atom trap; and
at least one controllable coherent signal source for emitting coherent control interventions of a matter wave interferometry sequence including coherent deflection control interventions, coherent beam splitter control interventions and/or coherent relaunch control interventions; and
at least one control device for controlling at least the at least one coherent signal source, wherein the control device is configured to carry out a method as claimed in claim 1.

13. A computer program non-transiently encoded on a memory medium comprising commands that cause the atom interferometer to carry out the method steps as claimed in claim 1 when the computer program is executed on a computer of a control device of an atom interferometer.
